(19) United States
(12) Patent Application Publication
(10) Pub. No.: US 2010/0228914 A1
(43) Pub. Date: Sep. 9, 2010

(54) DATA CACHING SYSTEM AND METHOD FOR IMPLEMENTING LARGE CAPACITY CACHE

(75) Inventors: Ming XIE, Shenzhen city (CN); Xing YAO, Shenzhen city (CN); Zhili XIAO, Shenzhen city (CN); Yue WU, Shenzhen city (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Tencent Technology (Shenzhen) Company, Ltd., Shenzhen (CN)

(21) Appl. No.: 12/781,333

(22) Filed: May 17, 2010

Related U.S. Application Data
(63) Continuation of application No. PCT/CN2008/073315, filed on Dec. 3, 2008.

(30) Foreign Application Priority Data
Dec. 3, 2007 (CN) 200710187584.8

(51) Int. Cl. G06F 12/08; G06F 12/00

(52) U.S. Cl. 711/113; 711/216; 711/E12.001; 711/E12.019

(57) ABSTRACT

Disclosed is a data caching system and a method for implementing a large capacity cache. The system includes: a record processing apparatus and a record storage apparatus which is configured with a first storage unit configured in a disk unit, a second storage unit and a third storage unit. The record processing apparatus is configured with a record inserting unit; the record inserting unit is adapted to store a record to be cached which comprises one or more data blocks into the first storage unit; the record inserting unit is further adapted to obtain addressing information of each data block of the record to be cached, configure one or more data block nodes in the second storage unit, and store the addressing information in the corresponding data block nodes; and the record inserting unit is further adapted to configure an index node in the third storage unit for the record to be cached, and establish an addressing relationship between the index node and the one or more data blocks of the record to be cached. The method and system provided by the present invention divide information related to the record into three parts according to their functions and store them separately, which sufficiently considers the characteristics of the cache.

### FIELD OF THE INVENTION

The present invention relates to computer techniques, and more particularly, to a data caching system and a method for implementing a large capacity cache.

### BACKGROUND OF THE INVENTION

In computer and Internet applications, in order to improve data access efficiency and system performance, data which is frequently accessed is generally stored in a cache manner. Since the speed for accessing a memory is far rapid than that for accessing an outside storage, the memory is usually selected as a storage medium for caching data in the conventional method.

A memory caching scheme is provided by the conventional method. In this scheme, a record is taken as a basic unit for accessing data. Each record has a piece of unique index information (e.g. a keyword), and different records are differentiated from each other according to their index information. In this memory caching solution, a memory unit is configured with a data block area and a node area. The data block area is used for storing actual data of the records and the node area is used for storing the index information of the records. The data block area stores the actual data in data blocks. One record may include one or more data blocks. In other words, one record may be stored in one data block or different data blocks of the data block area after being segmented. The multiple data blocks corresponding to the record form a data block link. The node area includes multiple index nodes. Each index node corresponds to a record. For example, each index node stores the index information corresponding to the record. In addition, each index node also stores addressing information of a first data block of one or more data blocks corresponding to the record. Through the addressing information, it is possible to address the saved one or more data blocks of the record. Hereinafter, each part of the memory unit will be described in detail.

1. The node area. It includes: multiple index nodes, a Hash bucket, a header structure, etc.

Each index node corresponds to a record. Multiple index nodes may form one or more Hash node links through a Hash transform. Since the index nodes are linked in a Hash manner, they may be referred to as Hash nodes.

The Hash transform is actually a kind of compression transform, i.e. transform an input of arbitrary length into an output of a fixed length (the output is referred to as a Hash value) through a specific Hash algorithm or a Hash function. One important feature of the Hash transform is that, different inputs may be transformed into the same output after a specific Hash transform. For example, the Hash transform is performed by a modulo operation, i.e. any figure mod 100 to map the figure into a number between 0-99.

A Hash value of a record may be obtained through performing the Hash transform on the index information of the record. And through performing the Hash transform on index information of different records, the same Hash value may be obtained. The index nodes which are used for storing the different index information corresponding to the same Hash value form a Hash node link. In other words, each possible Hash value corresponds to a Hash node link. One Hash node link may include one or more Hash nodes. And the Hash value of the record corresponding to the Hash node is the same as the Hash value of the Hash node link.

An index node in the node area may store the following information: index information of the record, a header pointer of a data block (or data block link) corresponding to the record, a pointer pointing to a posterior index node on the Hash node link. The index node may also store the following information: data length of the record, a pointer pointing to an anterior index node on the Hash node link, a pointer pointing to an anterior node on an additional link, a pointer pointing to a posterior node on the additional link, latest access time of the record, times of the record being accessed in the cache, etc. According to a least recently used (LRU) principle, the additional link eliminates the data seldom used out of the cache.

The Hash bucket mainly stores a header pointer of a Hash node link corresponding to each Hash value.

The header structure of the node area mainly stores macro information of the node area, including starting position information of the Hash bucket, number information of the Hash values in the Hash bucket, number of nodes in the node area, number of used nodes, number of used node links, a header pointer of an idle node link, header position information and tail position information of an addition link, etc.

2. The data block area. It includes a plurality of data blocks for storing the record to be cached.

If the data length of a record does not exceed the capacity of a data block, the record may be stored in one data block.

If the data length of the record exceeds the capacity of the data block, the record may be segmented into multiple data segments according to the capacity of the data block and then the data segments are stored in different data blocks. The data blocks form a data block link according to a segmented sequence of the record.

For a better understanding, FIG. 1 shows a structure of a memory unit for implementing the above caching solution. As shown in FIG. 1, there are four node links in the node area. The four node links respectively are: a Hash node link (denoted by a solid line) formed by node 11-node 12-node 22, a Hash node link (denoted by a solid line) formed by node 21, an additional link (denoted by a dashed line) formed by node 11-node 21-node 22-node 12, and an idle node link (denoted by a dashed line) formed by node 23-node 13.

The Hash bucket stores header pointers of the Hash node links. The Hash node links may be addressed according to the corresponding header pointers. The header structure of the node area stores header position information of the additional link. The additional link may be addressed according to the header position information. In addition, the header structure of the node area also stores header position information of the idle node link. The idle node link may be addressed according to the header position information.

There are two data block links in the data block area. The two data block links respectively are: a data block link (denoted by a solid line) formed by data block 11-data block 12-data block 22, and an idle data block link (denoted by a dashed line) formed by data block 21-data block 23-data block 13.

The node 21 stores a header pointer of the data block link formed by data block 11-data block 12-data block 22 (i.e. stores addressing information of the first data block, data block 11). The data block link may be addressed according to the header pointer. In addition, the header structure of the data block area also stores header position information of the idle data block link formed by data block 21-data block 23-data block 13. The idle data block link may be addressed according to the header position information.

In the above memory caching solution, after a record is segmented into multiple data blocks, the data blocks have linking relationships when being stored, i.e. the data blocks form a data block link. All the data related to the record is stored in the memory unit. Since hardware cost of the memory is relatively high, capacity of the memory is usually limited. Therefore, the number of records that can be cached in the memory is also limited.

### SUMMARY OF THE INVENTION

Embodiments of the present invention provide a data caching system and a method for implementing a large capacity cache.

According to an embodiment of the present invention, a data caching system is provided. The data caching system includes:

a record processing apparatus and a record storage apparatus which is configured with a first storage unit configured in a disk unit, a second storage unit and a third storage unit, wherein

the record processing apparatus is configured with a record inserting unit;

the record inserting unit is adapted to store a record to be cached which comprises one or more data blocks into the first storage unit;

the record inserting unit is further adapted to obtain addressing information of each data block of the record to be cached, configure one or more data block nodes in the second storage unit, and store the addressing information in the corresponding data block nodes; and

the record inserting unit is further adapted to configure an index node in the third storage unit for the record to be cached, and establish an addressing relationship between the index node and the one or more data blocks of the record to be cached.

According to another embodiment of the present invention, a method for implementing a large capacity cache is provided. The method includes:

storing a record to be cached comprising one or more data blocks in a data block area of a disk unit;

obtaining addressing information of each data block of the record to be cached, configuring one or more data block nodes in a data block node area of a memory unit, and storing the addressing information in the corresponding data block nodes; and

configuring an index node for the record to be cached in an index node area of the memory unit, and establishing an addressing relationship between the index node and the one or more data block nodes of the record to be cached.

It can be seen from the above that, in the embodiments of the present invention, when a record is cached, information related to the record is divided into three parts. The three parts are stored separately in order to fulfill the characteristic of the cache. Further, since the information of the three parts is stored separately, the actual data of the record may be stored in a disk unit which has a relatively low cost instead of being stored in the memory. In the memory unit, what is required to be stored is only the searching information of the record to be cached. The searching information of the record includes storage structure information and addressing information of the data blocks stored in the disk unit. As such, searching information of more records to be cached may be stored in the memory unit. And the capacity of the cache is increased by the embodiments of the present invention without increasing the cost.

### BRIEF DESCRIPTION OF THE DRAWINGS

FIG. 1 is a schematic diagram illustrating a memory caching solution in the prior art;

FIG. 2 is a schematic diagram illustrating a data caching system according to an embodiment of the present invention;

FIG. 3 is a schematic diagram illustrating a data caching system according to a first embodiment of the present invention;

FIG. 4 is a schematic diagram illustrating a data caching system according to a second embodiment of the present invention;

FIG. 5 is a schematic diagram illustrating a large capacity cache implemented by adopting a Hash manner according to an embodiment of the present invention;

FIG. 6 is a schematic diagram illustrating a large capacity cache implemented by adopting a link manner according to an embodiment of the present invention;

FIG. 7 is a schematic diagram illustrating a large capacity cache implemented by adopting a tree structure according to an embodiment of the present invention;

FIG. 8 is a flowchart illustrating a method for implementing a large capacity cache according to an embodiment of the present invention;

FIG. 9 is a flowchart of inserting a record in the large capacity cache according to an embodiment of the present invention;

FIG. 10 is a flowchart of retrieving a record from the large capacity cache according to an embodiment of the present invention; and

FIG. 11 is a flowchart of deleting a record from the large capacity cache according to an embodiment of the present invention.

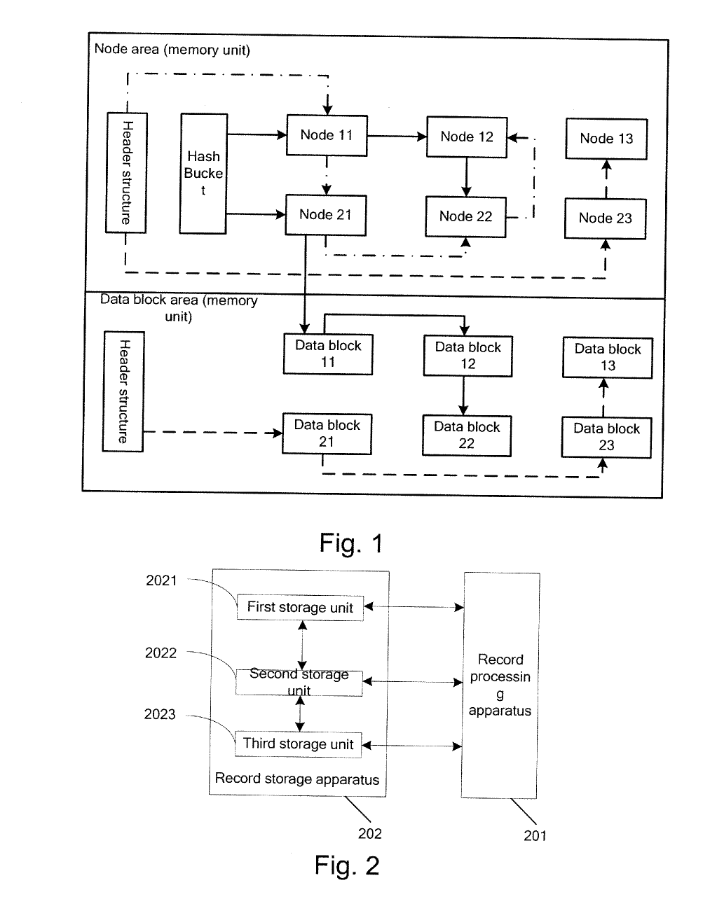

### DETAILED DESCRIPTION OF THE INVENTION

The present invention will be described in detail hereinafter with reference to accompanying drawings and embodiments to make the technical solution and merits therein clearer.

In the embodiments of the present invention, when a record is cached, all information related to the record is divided into three parts according to their functions: (1) one or more data blocks obtained by segmenting the record; (2) addressing address of the one or more data blocks; (3) index information of the record. What is recorded by the part (1) is the actual data, and that recorded by the parts (2) and (3) is the searching information of the record.

The relationships of the three parts are: the addressing address of the data blocks may be obtained through the index information of the record. And the corresponding data blocks may be found by the addressing address, and the actual data of the record may be obtained.

FIG. 2 is a schematic diagram illustrating a data caching system according to an embodiment of the present invention. The system includes: a record processing apparatus 201 and a record storage apparatus 202.

The record processing apparatus 201 is adapted to insert information related to a record into the record storage apparatus 202, or retrieve information related to the record from the record storage apparatus 202, or delete information related to the record from the record storage apparatus 202.

In particular, the record storage apparatus 202 is configured with a first storage unit 2021, a second storage unit 2022 and a third storage unit 2023. Accordingly, the record processing apparatus 201 is adapted to store a record to be cached which includes one or more data blocks in the first storage unit 2012. Furthermore, the record processing apparatus 201 is adapted to obtain addressing information of each data block of the record to be cached, configure one or more data block nodes in the second storage unit 2022, and store the addressing information of each data block in a corresponding data block node. Furthermore, the record processing apparatus 201 is adapted to configure an index node in the third storage unit 2023 for the record to be cached, and establish an addressing relationship between the index node and the one or more data block nodes of the record to be cached.

Further, in order to solve the problem that the number of records that can be cached is limited in the conventional method, embodiments of the present invention select a disk unit as a storage medium for the actual data of the record to be cached, i.e. the first storage unit 2021 is implemented by the disk unit. The second storage unit 2022 and the third storage unit 2023 may be implemented by a memory unit since they have less information to be stored.

In other words, in order to implement the caching of the data, on the one hand, a data block area is configured in the disk unit for storing the actual data of the record to be cached; and on the other hand, an index node area and a data block node area is configured in the memory unit. Herein, the index node area is the third storage area 2023, adapted to store storage structure information of multiple records according to a certain data structure. The data structure may be a Hash structure, a tree structure, a link structure, etc. The data block node area is the second storage unit 2022, adapted to store addressing information of the one or more data blocks of the record. The data block area is the first storage unit 2021 which is configured in the disk unit. Certainly, in other embodiments of the present invention, the data block area may also be configured in the memory unit.

### A First Embodiment

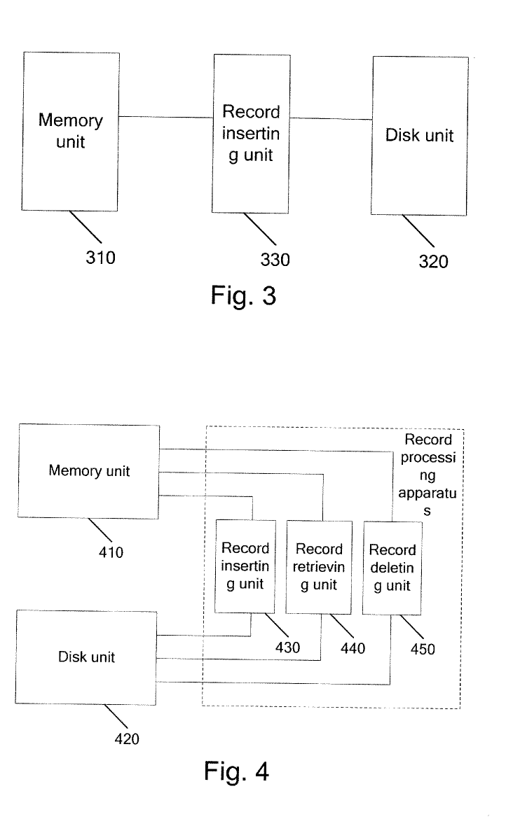

FIG. 3 shows a data caching system according to the first embodiment of the present invention. As shown in FIG. 3, the system includes a memory unit 310, a disk unit 320 and a record inserting unit 330.

The record inserting unit 330 is adapted to allocate corresponding data blocks for a record to be cached in a data block area of the disk unit, and store data segments of the record in the data blocks allocated. Furthermore, the record inserting unit 330 is adapted to allocate, in the data block node area of the memory unit, a data block node corresponding to each data block, and store addressing information of each data block in the corresponding data block node. Furthermore, the record inserting unit 330 is adapted to allocate, in the index node area of the memory unit, an index node corresponding to the record to be cached.

The index node may be a Hash node after a Hash transform. After the Hash transform to the index information of the record to be cached, a corresponding Hash value may be obtained. The Hash nodes is added to a Hash node link corresponding to the Hash value according to the Hash value and the index information of the record to be cached and addressing information of a corresponding data block node (the first data block) are stored in the Hash node. As such, it is possible to search for the record in the Hash manner.

Alternatively, index nodes of multiple records may be stored by taking a link as a data structure. In particular, when caching a record, if there is no repeated index information on a link, then a node on the head or the tail of the link is created. When searching for the record, the whole link is traversed. When deleting the record, the record is also searched for by traversing the link and then the corresponding index node is deleted from the link.

Alternatively, the index nodes of multiple records may also be stored by taking a tree as a data structure. It should be noted that, with respect to the performance of searching for a record, the tree structure is better than the link but is far slower than the Hash manner.

### A Second Embodiment

FIG. 4 shows a data caching system according to the second embodiment of the present invention. As shown in FIG. 4, the system includes: a memory unit 410, a disk unit 420, a record inserting unit 430, a record retrieving unit 440 and a record deleting unit 450.

The record inserting unit 430 is adapted to determine, according to a data length of a record to be cached and a capacity of a data block, a number N of data blocks required for storing the record to be cached, and segmenting the record to be cached into N data segments according the capacity of the data block.

The disk unit 420 is adapted to allocate corresponding number of data blocks for the record to be cached in a data block area. Wherein, each data block is used for storing a data segment. It should be noted that physical addresses of the data blocks may be not consecutive.

The memory unit 410 is configured with a data block node area. In the data block node area, a corresponding data block node is allocated for each data block storing the data segment. The allocated data block nodes are linked to form a data block node link of the record to be cached, wherein each data block node is adapted to store addressing information of the corresponding data block.

Furthermore, the memory unit 410 is configured with a Hash node area. In the Hash node area, a corresponding Hash node is allocated for the record to be cached. The Hash node is adapted to store index information of the record to be cached and addressing information of the data block node link of the record to be cached. A corresponding Hash value is obtained through performing a Hash transform on the index information, and the Hash node is added to a Hash node link corresponding to the Hash value.

After storing the record to be cached according to the above structure, it is possible to retrieve the record through the record retrieving unit 440 and delete the record through the record deleting unit 450. The specified process is as follows.

The record retrieving unit 440 is adapted to perform a Hash transform on the index information of the record to be retrieved to obtain a corresponding Hash value, search for a Hash node link corresponding to the Hash value in the Hash node area of the memory unit 410 according to the Hash value. Then, the record retrieving unit 440 finds a Hash node which stores the index information of the record to be retrieved from the Hash node link searched out, and addresses a corresponding data block node link in the memory unit 410 according to addressing information of the data block node link stored in the Hash node. Then, the record retrieving unit 440 addresses, according to addressing information of the data blocks stored in the data block nodes in the data block link, all the corresponding data blocks in the disk unit 420, retrieve the data segments from the data blocks and assemble the data segments.

The record deleting unit 450 is adapted to perform a Hash transform on the index information of the record to be deleted to obtain a corresponding Hash value, and search for a Hash node link corresponding to the Hash value in the Hash node area of the memory unit 410. Then, the record deleting unit 450 finds a Hash node which stores the index information of the record to be deleted from the Hash node link searched out, and recycles the Hash node and the corresponding data block node link.

In other embodiments of the present invention, the data caching system may further include a log unit, adapted to generate a log file according to contents stored in the data block node area and the Hash node area of the memory unit, and store the log file in the disk unit. Thus, in case of accidental power-off, relevant contents of the data block area and the Hash node area may be recovered rapidly according to the log file stored in the disk unit.

In the above embodiments of the present invention, the disk unit may be any kind of external computer-readable storage medium, such as hard-disk, floppy disk, compact disk, etc.

In practical applications, since the disk usually has a large capacity, the capacity of the data block may be set a little larger, so that a record can be stored in one data block without being segmented. As such, the number of the data block nodes is reduced and resources of the memory unit are saved. On the other hand, it avoids segmentation of the record, which makes it possible to store each record continuously in the disk unit instead of storing in different data blocks. Thus, access speed of the data can be increased.

When describing the working principle of the record inserting unit 430, the record retrieving unit 440 and the record deleting unit 450 in FIG. 4, some concepts including the Hash node area, the data block node area and the data block area are used. Hereinafter, the Hash node area, the data block node area and the data block area are described in detail.

1. The Hash node area: configured in the memory unit, including a header structure of a Hash node area, a Hash bucket and a plurality of Hash nodes.

In the solution of the present invention, a record is taken as a unit for accessing data. A Hash value of a record may be obtained through performing a Hash transform on the index information of the record. And a same Hash value may be obtained through performing the Hash transform on index information of different records. Accordingly, each possible Hash value may correspond to a Hash node link. Each Hash node link includes one or more Hash nodes. And each Hash node corresponds to a record. The Hash value of the record is the same as that of the Hash node link where the record is located.

Information stored in the Hash node of the Hash node area includes: the index information of the record, a header pointer of a data block node link corresponding to the record, and a pointer points to a posterior Hash node on the Hash node link of the record. The information stored in the Hash node of the Hash node area may further include: data length of the record, a pointer points to an anterior Hash node on the Hash node link of the record, a pointer points to an anterior Hash node on an additional link, a pointer points a posterior Hash node on the additional link, latest access time of the record, times of the record being accessed in the cache, etc. The pointer points to the anterior Hash node on the additional link and the pointer points to the posterior Hash node on the additional link are not available before the Hash node is added to the additional link.

The Hash bucket is mainly adapted to store a header pointer of the Hash node link corresponding to each Hash value.

The header structure of the Hash node area is mainly adapted to store macro information of the Hash node area, including starting position information of the Hash bucket, number information of the Hash values in the Hash bucket, number of Hash nodes in the Hash node area, number of Hash nodes having been used, number of Hash node links having been used, a header pointer of an idle node link, header position information and tail position information of the additional link, etc.

2. The data block node area: configured in the memory unit, including a header structure of the data block node area and a plurality of data block nodes.

In the Hash node area, each Hash value corresponds to a Hash node link and each Hash node in the Hash node link corresponds to a record. In the data block node area, each record corresponds to a data block node link, and the Hash node corresponding to the record stores the addressing information of the data block node link corresponding to the record. Thus, the data block node link can be addressed.

The number of the data block nodes in the data block node link corresponding to one record is the same as the number of the data blocks storing the record. Each data block node corresponds to one data block. Therefore, if the data block node link corresponding to one record has multiple data block nodes, each data block node needs to store a pointer points to a posterior data block node on the same data block node link as well as the addressing information of a corresponding data block (may be an offset of the data block in the disk unit). The data block node may further store a length of the data stored in the corresponding data block.

The information stored in the header structure of the data block node area includes: number of data block nodes in the data block node area, capacity of the data block, number of idle data block nodes, a header pointer of an idle data block node link, and a header pointer of a data block node link having been used.

3. The data block area: configured in the disk unit, including a plurality of data blocks, adapted to store the data to be cached. If the data length of a record does not exceed the capacity of one data block, all the data of the record may be stored in one data block. If the data length of a record exceeds the capacity of one data block, the record should be segmented according to the capacity of the data block. Then the data segments are stored in different data blocks.

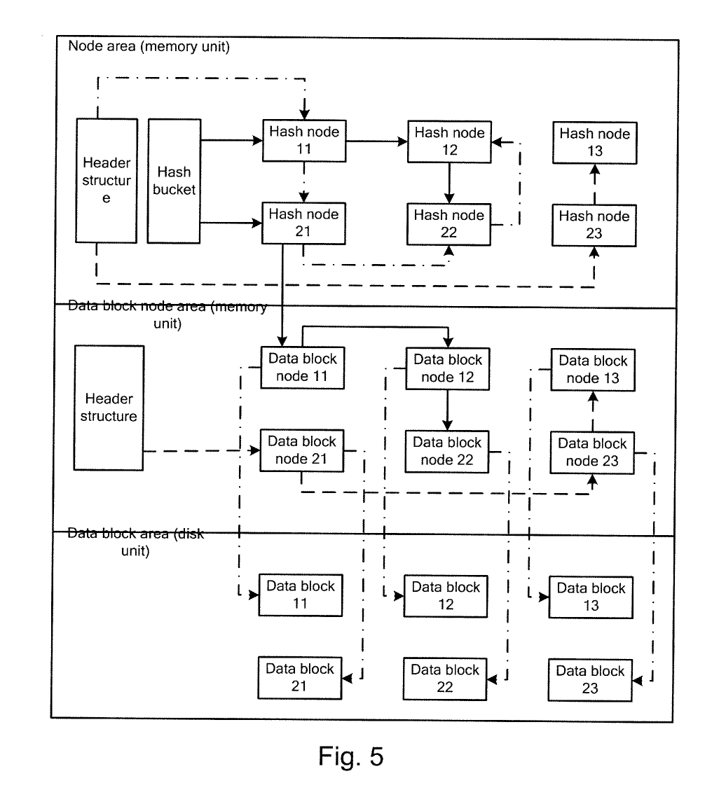

In order to understand the three-layer structure of the Hash node area, the data block node area and the data block area, FIG. 5 shows a schematic diagram of a large capacity cache adopting the Hash manner according to an embodiment of the present invention.

In the Hash node area of the memory unit of FIG. 5, Hash node 11, Hash node 12, Hash node 22 form a Hash node link, and Hash node 21 is another Hash node link. The Hash bucket stores the header pointer of the Hash node links. The Hash node links may be addressed according to the corresponding header pointers.

Hash node 11, Hash node 21, Hash node 22, and Hash node 12 form an additional link. The header structure of the Hash node area stores the header position information of the additional link. The additional link may be addressed according to the header position information.

Hash node 23 and Hash node 12 form an idle Hash node link, the header structure of the Hash node area stores the header position information of the idle Hash node link. The idle Hash node link may be addressed according to the header position information.

In the data block node area of the memory unit, data block node 11, data block node 12 and data block node 22 form a data block node link. The data block node link corresponds to the Hash node 21 in the Hash node area. The Hash node 21 stores a header pointer of the data block node link (addressing information of the data block node 11). The data block node link may be addressed according to the header pointer.

Data block node 21, data block node 23, and data block node 13 form an idle data block node link. The header structure of the data block node area stores header position information of the idle data block node link. The idle data block node link may be addressed according to the header information. The data bock nodes are respectively corresponding to the data blocks in the data block area of the disk unit. The data block nodes also store the addressing information of the corresponding data blocks.

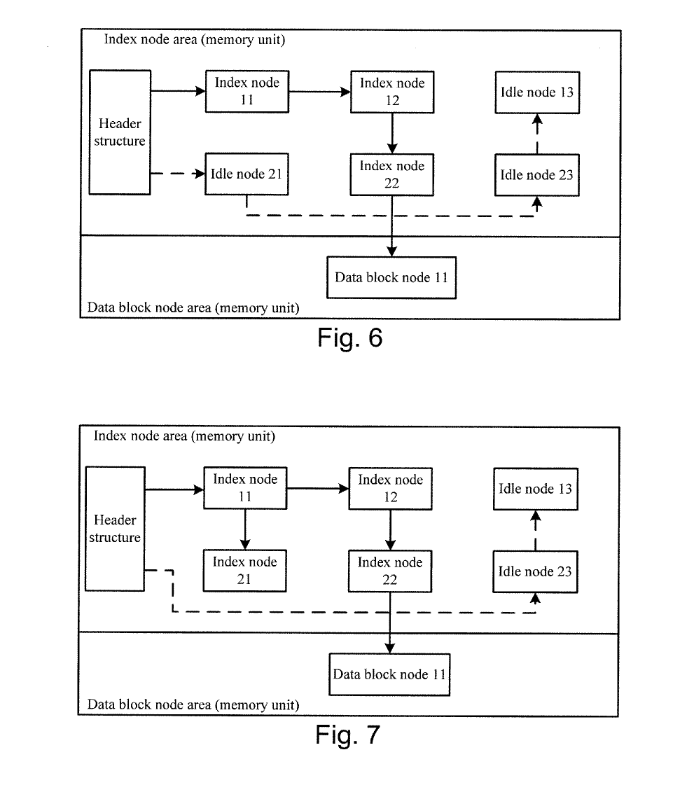

In addition, the corresponding relationships between the multiple index nodes may also be established by adopting other data structures such as a tree structure or a link structure. The detailed implementations are shown in FIG. 6 and FIG. 7, wherein the data block area in the disk unit is similar to that in FIG. 5 and therefore is not shown in FIG. 6 and FIG. 7. In FIG. 6 and FIG. 7, the data block node link corresponding to the data block node 11 in the data block node area of the memory unit may be addressed through the index node 22.

In FIG. 6, index node 11, index node 12 and index node 22 form a link structure. In FIG. 7, index node 11, index node 12, index node 21 and index node 22 form a tree structure.

Based on the above system structure, embodiments of the present invention also provide a method for implementing a large capacity cache.

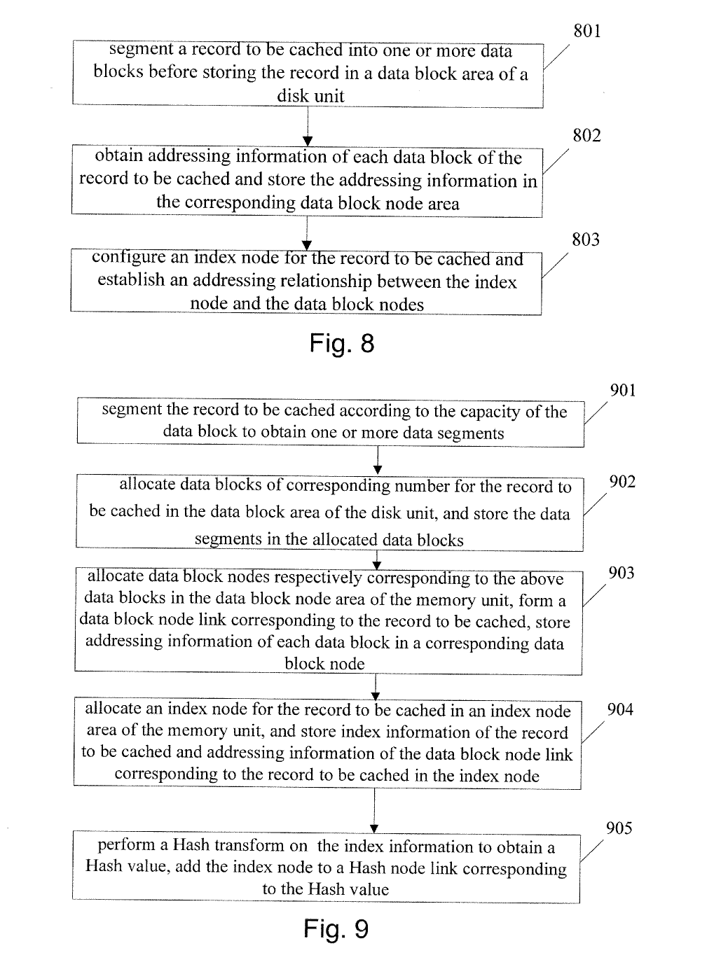

FIG. 8 is a flowchart illustrating a method for implementing a large capacity cache according to an embodiment of the present invention. As shown in FIG. 8, the method includes the following processes.

Block 801, segment a record to be cached into one or more data blocks before storing the record in a data block area of a disk unit.

In particular, corresponding data blocks are allocated for the record to be cached in the data block area of the disk unit and the data segments of the record are stored into the allocated data blocks.

Block 802, obtain addressing information of each data block of the record to be cached. Data block nodes are configured in the data block node area of the memory unit and the addressing information is stored in the corresponding data block nodes.

In particular, data block nodes corresponding to the above data blocks are allocated in the data block node area of the memory unit, the addressing information of the data blocks is stored in the corresponding data block nodes. One data block node stores the addressing information of one data block. All the data block nodes of the record to be cached form a data block node link.

Block 803, configure an index node for the record to be cached in an index node area of the memory unit, establish an addressing relationship between the index node and the data block nodes of the record to be cached.

In particular, a corresponding index node is allocated for the record to be cached in the index node area of the memory unit, and at least one piece of the following information: index information of the record to be cached, addressing information of the data bock node link corresponding to the record to be cached is stored in the index node.

In embodiments of the present invention, the actual data of the record to be cached is no longer directly stored in the memory unit. Instead, it is stored in the disk unit which has a relatively low cost. As such, the memory unit only needs to store storage structure information of the record to be cached and addressing information of the one or more data blocks of each record in the disk unit. Thus, searching information of more records may be stored in the memory unit. Accordingly, the capacity of the cache is increased without increasing the cost.

It should be noted that, in the blocks 801-803, the operations of allocating the data blocks, allocating data block nodes and allocating the index node may be performed according to any sequence or performed simultaneously. It does not affect the implementation of the present invention.

In another embodiment of the present invention, a method for inserting a record in the large capacity cache is shown in FIG. 9, which includes the following blocks.

Block 901, determine the number of data blocks required for storing the record according to the data length of the record and the capacity of the data block, and segment the record according to the capacity of the data block to obtain one or more data segments.

Block 902, allocate data blocks of corresponding number for the record to be cached in the data block area of the disk unit, and store the data segments in the allocated data blocks.

In particular, the data segments are respectively stored in the allocated data blocks. One data segment is stored in one data block.

Block 903, allocate data block nodes respectively corresponding to the above data blocks in the data block node area of the memory unit, link the allocated data block nodes to form a data block node link corresponding to the record to be cached, store addressing information of each data block in a corresponding data block node.

In particular, the allocation of the data block nodes respectively corresponding to the data blocks may be implemented by getting data block nodes of corresponding number from an idle data block node link.

In addition, the allocated data block nodes may be linked through storing, in each data block node, a pointer points to an adjacent data block node to form the data block node link corresponding to the record to be cached.

Since the data block nodes and the data blocks are respectively corresponding to each other, the data segments of the record stored in multiple data blocks may be associated with other. Thus, operations to all the data segments of the record can be performed.

Block 904, allocate an index node for the record to be cached in an index node area of the memory unit, and store index information of the record to be cached and addressing information (may be a header pointer points to the data block node link) of the data block node link corresponding to the record to be cached in the index node.

Block 905, perform a Hash transform on the index information of the record to be cached to obtain a Hash value, add the index node to a Hash node link corresponding to the Hash value.

In particular, the allocation of the Hash node to the record to be cached in the Hash node area may be implemented by obtaining a Hash node from an idle node link.

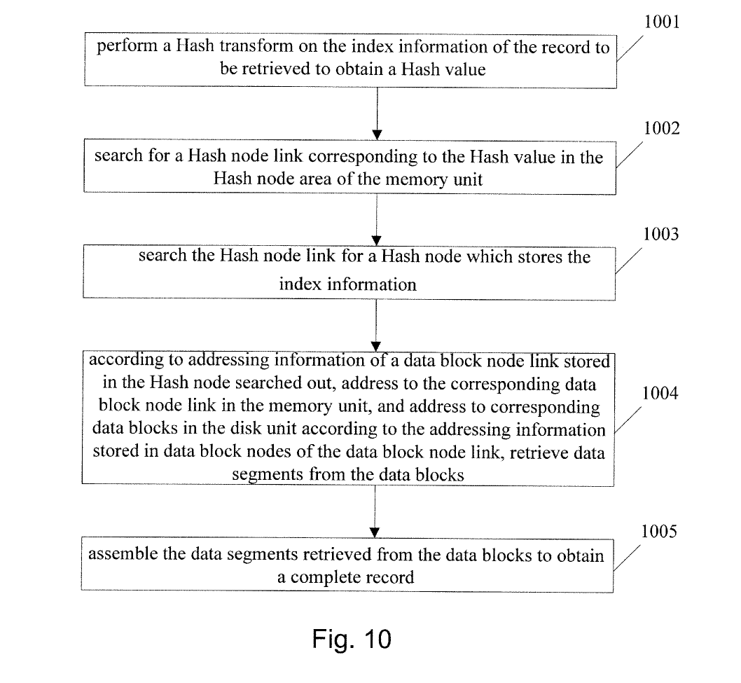

FIG. 10 is a flowchart illustrating a method for retrieving a record from the large capacity cache according to an embodiment of the present invention. As shown in FIG. 10, the method includes:

Block 1001, perform a Hash transform on the index information of the record to be retrieved to obtain a Hash value.

Block 1002, search for a Hash node link corresponding to the Hash value in the Hash node area of the memory unit.

Block 1003, search the Hash node link for a Hash node which stores the index information.

Block 1004, according to addressing information of a data block node link stored in the Hash node searched out, address to the corresponding data block node link in the memory unit, and address to corresponding data blocks in the disk unit according to the addressing information stored in data block nodes of the data block node link, and retrieve data segments from the data blocks.

As to the situation that the record is segmented into multiple data segments for storage, block 1005 may be further performed.

Block 1005, according to the corresponding relationship between the data block nodes and the data blocks, and according to the linked situation of the data block nodes on the data block node link, assemble the data segments retrieved from the data blocks to obtain a complete record.

In particular, take FIG. 5 as an example, the linked situation of the data block nodes on the data block node link is as follows: data block node 11 linked to data block node 12 and data block node 12 linked to data block node 22. The corresponding relationship between the data blocks and the data block nodes is: data block node 11 points to data block 11, data block node 12 points to data block 12, and data block node 22 points to data block 22. Therefore, when assembling the data segments, the data block 11 is assembled with the data block 12 first, and then the data block 12 is assembled with data block 22 to obtain the record.

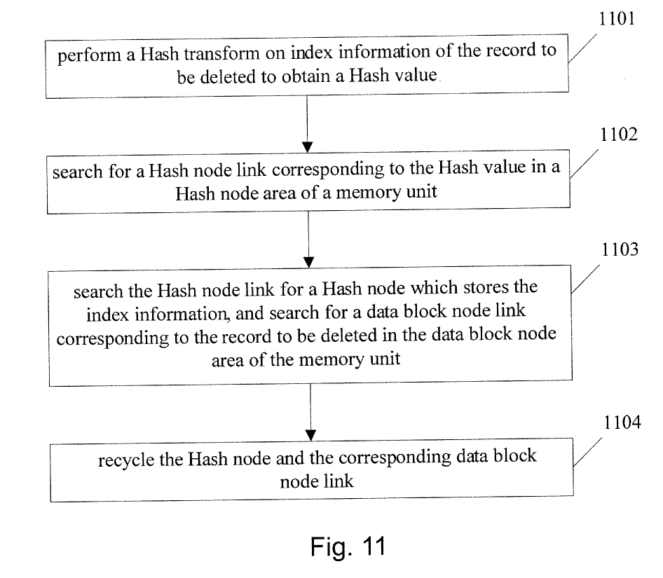

FIG. 11 is a flowchart illustrating a method for deleting a record from the large capacity cache according to an embodiment of the present invention. As shown in FIG. 11, the method includes:

Block 1101, perform a Hash transform on index information of the record to be deleted to obtain a Hash value.

Block 1102, search for a Hash node link corresponding to the Hash value in a Hash node area of a memory unit.

Block 1103, search the Hash node link for a Hash node which stores the index information, and search for a data block node link corresponding to the record to be deleted in the data block node area of the memory unit.

Block 1104, recycle the Hash node and the corresponding data block node link.

In this block, the recycling of the Hash node may be implemented by putting the Hash node back to an idle node link. Similarly, the recycling of the data block node link may be implemented by putting each data block node on the data block node link back to an idle data block node link.

The foregoing descriptions are only preferred embodiments of the data caching system and the method for implementing the large capacity cache. Particular instances are applied to introduce the principle and implementation of the present invention. The above embodiments are only used for facilitating the understanding of the present invention. Any changes and modifications can be made by those skilled in the art without departing from the spirit of this invention and therefore should be covered within the protection scope as set by the appended claims. Contents of the description are not used for limiting the present invention.

What is claimed is:

1. A data caching system, comprising: a record processing apparatus and a record storage apparatus which is configured with a first storage unit configured in a disk unit, a second storage unit and a third storage unit, wherein
the record processing apparatus is configured with a record inserting unit;
the record inserting unit is adapted to store a record to be cached which comprises one or more data blocks into the first storage unit;
the record inserting unit is further adapted to obtain addressing information of each data block of the record to be cached, configure one or more data block nodes in the second storage unit, and store the addressing information in the corresponding data block nodes; and
the record inserting unit is further adapted to configure an index node in the third storage unit for the record to be cached, and establish an addressing relationship between the index node and the one or more data blocks of the record to be cached.

2. The data caching system of claim 1, wherein the record inserting unit is further adapted to form a data block node link with the one or more data blocks which respectively store the addressing information of the data blocks of the record to be cached, and store addressing information of the data block node link in the index node corresponding to the record to be cached in the third storage unit.

3. The data caching system of claim 1, wherein the record inserting unit is further adapted to store index nodes of multiple records according to a pre-defined data structure.

4. The data caching system of claim 3, wherein the pre-defined data structure is a Hash structure, or a link structure or a tree structure.

5. The data caching system of claim 4, wherein the record inserting unit is further adapted to perform a Hash transform on index information of the record to be cached to obtain a Hash value, and add the index node corresponding to the record to be cached to a Hash node link having the same Hash value in the third storage unit.

6. The data caching system of claim 1, wherein the record processing apparatus is further configured with a record retrieving unit, adapted to search in the third storage unit for an index node corresponding to a record to be retrieved, search for one or more data block nodes in the second storage unit according to the addressing relationship between the index node and the one or more data block nodes to obtain addressing information of one or more data blocks of the record to be retrieved, and obtain one or more data blocks of the record to be retrieved from the first storage unit according to the addressing information.

7. The data caching system of claim 6, wherein the record retrieving unit is further adapted to calculate a Hash value according to index information of the record to be retrieved, find a corresponding Hash node link according to the Hash value, and find the index node of the record to be retrieved from the Hash node link according to the index information.

8. The data caching system of claim 1, wherein the record processing apparatus is further configured with a record deleting unit, adapted to find an index node corresponding to a record to be deleted in the third storage unit, search for one or more data block nodes storing addressing information of one or more data blocks of the record to be deleted in the second storage unit according to the index node, and recycle the index node and the one or more data block nodes.

9. The data caching system of claim 1, wherein the first storage unit is a data block area in the disk unit;
the second storage unit is a data block node area in a memory unit; and
the third storage unit is an index node area in the memory unit.

10. The data caching system of claim 9, wherein the disk unit is a hardware disk, or a floppy disk or a compact disk.

11. The data caching system of claim 9, further comprising:
a log unit, adapted to generate a log according to contents of the data block node area and the index node area in the memory unit, and store the log in the disk unit.

12. A method for implementing a large capacity cache, comprising:
storing a record to be cached comprising one or more data blocks in a data block area of a disk unit;
obtaining addressing information of each data block of the record to be cached, configuring one or more data block nodes in a data block node area of a memory unit, and storing the addressing information in the corresponding data block nodes; and
configuring an index node for the record to be cached in an index node area of the memory unit, and establishing an addressing relationship between the index node and the one or more data block nodes of the record to be cached.

13. The method of claim 12, further comprising:
forming a data block node link by the one or more data block nodes corresponding to the record to be cached; and storing addressing information of the data block node link in the index node corresponding to the record to be cached in the index node area of the memory unit.

14. The method of claim 12, further comprising:
storing index nodes of multiple records according to a pre-defined data structure.

15. The method of claim 14, wherein the pre-defined data structure is a Hash structure, or a link structure or a tree structure.

16. The method of claim 15, further comprising:
performing a Hash transform on index information of the record to be cached to obtain a Hash value, and
adding the index node corresponding to the record to be cached to a Hash node link having the same Hash value in the index node area of the memory unit.

17. The method of claim 12, further comprising:
searching for an index node of a record to be retrieved in the index node area of the memory unit;
searching for one or more data block nodes in the data block area of the memory unit according to the addressing relationship between the index node and the one or more data block nodes to obtain addressing information of one or more data blocks of the record to be retrieved; and
obtaining one or more data blocks of the record to be retrieved from the data block area of the disk unit according to the addressing information.

18. The method of claim 17, further comprising:
calculating a Hash value according to index information of the record to be retrieved, finding a corresponding Hash node link according to the Hash value, and searching the Hash node link for an index node of the record to be retrieved according to the index information.

19. The method of claim 12, further comprising:
searching for an index node of a record to be deleted in the index node area of the memory unit;
searching for one or more data block nodes which store addressing information of one or more data blocks of the record to be deleted in the data block node area of the memory unit according to the index node; and
recycling the index node and the one or more data block nodes.
